(19) United States
(12) Patent Application Publication
(10) Pub. No.: US 2008/0108381 A1
(43) Pub. Date: May 8, 2008

(54) Mobile device having display button and method and medium of displaying using the display button

(75) Inventors: Young-Jin Hong, Suwon-si (KR); Soo-Hyun Bae, Seoul (KR); Seong-Woon Kim, Yongin-si (KR); Hyun-Jeong Lee, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/907,951

(22) Filed: Oct. 18, 2007

Related U.S. Application Data
(63) Continuation of application No. PCT/KR2006/001856, filed on May 18, 2006.

(30) Foreign Application Priority Data
May 18, 2005 (KR) 10-2005-0041764
Oct. 7, 2005 (KR) 10-2005-0094510
May 17, 2006 (KR) 10-2006-0044401

(51) Int. Cl. H04M 1/00

(52) U.S. Cl. 455/550.1

(57) ABSTRACT

Provided is a mobile device having buttons having a display function and a display method for the mobile device. The mobile device includes a plurality of buttons, which display a plurality of characters in response to a control signal, and a controller generating the control signal for commanding the plurality of buttons to display characters indicated by character data corresponding to an operation result of the button from among prepared (predetermined) character data.

### CROSS-REFERENCE TO RELATED APPLICATIONS

This application is a continuation application of PCT/KR2006/001856 and claims the priority benefit of PCT/KR2006/001856, the disclosure of which is incorporated herein in its entirety by reference. This application also claims the priority benefit of Korean Patent Application No. 10-2005-0041764, filed on May 18, 2005, Korean Patent Application No. 10-2005-0094510, filed on Oct. 7, 2005, and Korean Patent Application No. 10-2006-0044401, filed on May 17, 2006 in the Korean Intellectual Property Office, the disclosures of which are incorporated herein in its entirety by reference.

### BACKGROUND

1. Field

Embodiments relate to a mobile device (terminal) such as a cellular phone, and more particularly, to a mobile device (terminal) having image display buttons and a display method for the mobile device (terminal).

2. Description of the Related Art

In general, a terminal (mobile device), such as a cellular phone, has a plurality of buttons. A user selects a specific function from among various available functions, e.g., a phone call function, a short message editing and sending function, and a video file replay function, by pressing the plurality of buttons, and the terminal performs the selected specific function.

Thus, as the number of functions available in the terminal increases, the user who wants to select a specific function must perform an increasingly larger number of button pressing operations. Considering a recent trend in which cellular phones for performing various functions, such as a phone call function, a music replay function, a video file replay function, and an Internet surfing function, has higher market competitiveness than cellular phones for performing only a simple phone call function, it is predicted that the troublesomeness is profounder in a current button system.

In addition, if the number of functions available in the terminal is larger, the number of usages of each button is larger, and thus, the size of letters engraved on the surface of each button to represent the usages of the button is smaller, whereby a person having poor sight may feel difficulty when operating each button.

In another way, a method of installing a large number of buttons in a terminal to reduce the number of user's button inputs can be considered, however, according to a recent trend of following miniaturization of products, the size of buttons included in the terminal must be smaller, and thus, it may be difficult to operate the buttons.

### SUMMARY

In an aspect, a mobile device has a plurality of buttons having a display function in which a plurality of characters determined according to an operation result of the plurality of buttons are displayed on the plurality of buttons.

In an aspect, a mobile device has a plurality of buttons having a display function in which a plurality of characters determined according to an operation result of the plurality of buttons are displayed on the plurality of buttons.

In an aspect, a computer readable recording medium stores programs for executing a method of displaying a plurality of characters determined according to an operation result of the plurality of buttons on the plurality of buttons of a mobile device.

According to an aspect, there is provided a mobile device having buttons having a display function, the mobile device including a plurality of buttons, which display a plurality of characters in response to a control signal; and a controller which generates the control signal for commanding the plurality of buttons to display characters indicated by character data corresponding to an operation result of at least one button from among predetermined character data.

According to another aspect, there is provided a display method performed in a mobile device having a plurality of buttons, the method including displaying a plurality of characters on the plurality of buttons; operating at least one button and updating the plurality of characters according to the operation result; and displaying the plurality of updated characters on the plurality of buttons.

According to another aspect, there is provided a computer readable recording medium storing programs for executing a display method performed in a mobile device having a plurality of buttons, the method including displaying a plurality of characters on the plurality of buttons; operating at least one button and updating the plurality of characters according to the operation result; and displaying the plurality of updated characters on the plurality of buttons.

According to another aspect of the present invention, there is provided at least one computer readable medium storing computer readable instructions to implement display methods.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. These and/or other aspects, features, and advantages will become apparent and more readily appreciated from the following description of exemplary embodiments, taken in conjunction with the accompanying drawings of which:

FIG. 1 is a block diagram for explaining a terminal having buttons having a display function according to an exemplary embodiment;

FIG. 2 illustrates an unfolded figure of a folder-type cellular phone having buttons having a display function according to an exemplary embodiment;

FIGS. 3A and 3B are reference diagrams for explaining a button operation process required to edit a short message in Korean using the cellular phone illustrated in FIG. 2, according to an exemplary embodiment;

FIG. 4 is a reference diagram for explaining a button operation process required to edit a short message in Korean using the cellular phone illustrated in FIG. 2, according to another exemplary embodiment;

FIG. 5 is a reference diagram for explaining a button operation process required to edit a short message in Korean using the cellular phone illustrated in FIG. 2, according to another exemplary embodiment;

FIGS. 6A through 6C are reference diagrams for explaining a button operation process required to edit a short message in English using the cellular phone illustrated in FIG. 2, according to an exemplary embodiment;

FIGS. 7A and 7B are reference diagrams for explaining a button operation process required to edit a short message in English using the cellular phone illustrated in FIG. 2, according to another exemplary embodiment; and

FIG. 8 is a flowchart illustrating a display method according to an exemplary embodiment.

### DETAILED DESCRIPTION OF EMBODIMENTS

Reference will now be made in detail to exemplary embodiments, examples of which are illustrated in the accompanying drawings, wherein like reference numerals refer to the like elements throughout. Exemplary embodiments are described below by referring to the figures.

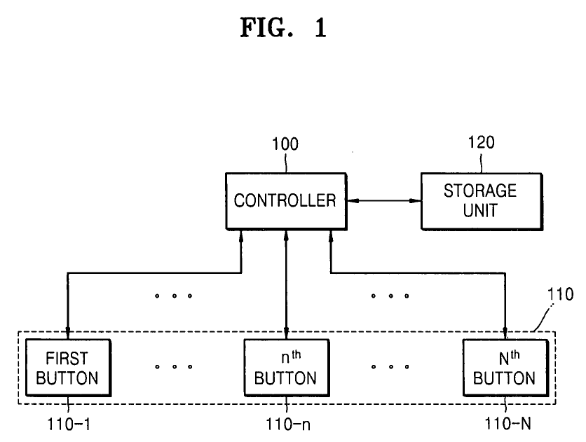

FIG. 1 is a block diagram for explaining a terminal (mobile device) having buttons having a display function according to an exemplary embodiment. Examples of a terminal (mobile device) having buttons having a display function according to an exemplary embodiment include a cellular phone, a personal digital assistant (PDA), MP3 player, digital camera, portable media player, and portable game player. However, any portable (mobile) electronic device having display buttons having a display function may include an exemplary embodiment. The terminal (mobile device) includes a controller 100, a plurality of buttons 110, and a storage unit 120. The plurality of buttons 110 include a first button 110-1 through an N^{th} button (110-N). Herein, n and N are integers where 1≦n≦N (N is greater than 2).

The controller 100 generates a control signal, and the plurality of buttons 110 display a plurality of characters, e.g., N characters, in response to the control signal. The characters may be letters.

The control signal is a signal for commanding to display letters indicated by character data (e.g. letter data) corresponding to an operation result of the buttons 110-1, . . . , 110-n, . . . , 110-N from among prepared (predetermined) character data (e.g., letter data).

Herein, an operation of each button can be achieved by pressing the button or touching the button. For example, an operation of each button can indicate that a user presses the button or touches a fingertip on the button.

The operation result of the buttons 110 can indicate an answer responding to a question ‘how to operate which button among the plurality of buttons 110’. For example, ‘a third button 110-3 is instantaneously pressed once’ and ‘a seventh button 110-7 is continuously touched for more than 1 second’ may be examples of operating the buttons 110 to provide an operation result. A plurality of characters (letters) displayed on the plurality of buttons 110 are updated according to the operation result of the buttons 110 every time at least one button is operated.

The storage unit 120 can be prepared inside or outside the terminal having buttons having a display function according to an exemplary embodiment. Unlike the storage unit 120, the controller 100 and the plurality of buttons 110 may be prepared inside the terminal having buttons having a display function according to an exemplary embodiment.

The prepared character data is stored in the storage unit 120.

Thus, the controller 100 reads character data corresponding to an operation result of the buttons 110-1, . . . , 110-n, . . . , 110-N from among the prepared character data, generates a control signal for commanding to display letters indicated by the read letter data, and transmits the generated control signal and the read letter data to the plurality of buttons 110.

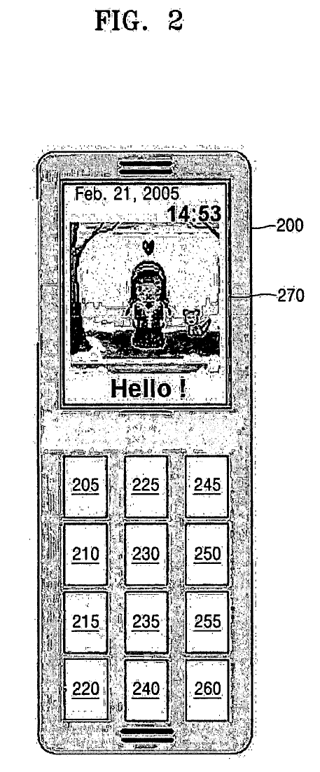

FIG. 2 illustrates an unfolded figure of a folder-type cellular phone 200 having buttons having a display function according to an exemplary embodiment. That is, FIG. 2 illustrates a case where the terminal according to an exemplary embodiment is implemented by the cellular phone 200. The cellular phone 200 includes 12 buttons 205 through 260. In detail, reference numerals 205, 210, 215, 220, 225, 230, 235, 240, 245, 250, 255, and 260 denote first, second, third, fourth, fifth, sixth, seventh, eighth, ninth, tenth, eleventh, and twelfth buttons, respectively. The cellular phone 200 also includes a display window 270.

The plurality of buttons 205 through 260 can display images indicating functions available in the cellular phone 200 as soon as the user unfolds the folder of the cellular phone 200. For example, if the cellular phone 200 can perform a phone call function, a message function, an Internet surfing function, an image capture function, a music search function, a music replay function, a still image search function, a still image reproduction function, a video search function, and a video replay function, the plurality of buttons 205 through 260 can display images indicating the above-described functions.

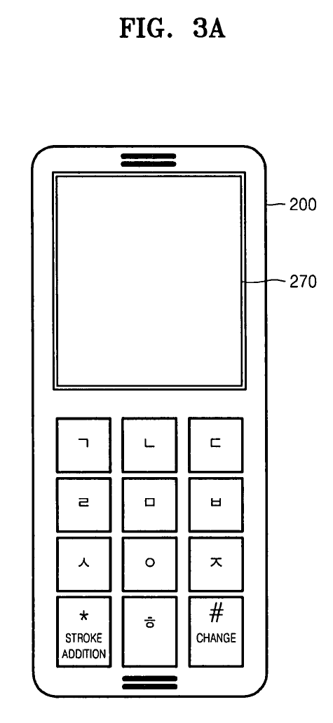

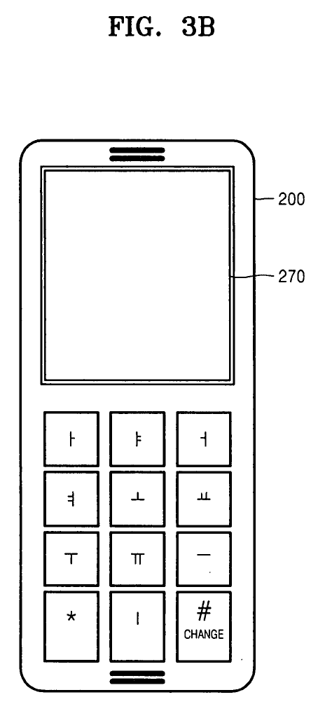

A method of inputting characters using a terminal having buttons having a display function will now be described with reference to FIGS. 3A through 7B.

FIGS. 3A and 3B are reference diagrams for explaining a button operation process required to edit a short message in Korean using the cellular phone 200 illustrated in FIG. 2, according to an exemplary embodiment.

According to the current exemplary embodiment, when the plurality of buttons 205 through 260 display Korean, the plurality of buttons 205 through 260 can display only Korean consonants or Korean vowels. In detail, the plurality of buttons 205 through 260 can display a plurality of Korean consonants illustrated in FIG. 3A or display a plurality of Korean vowels illustrated in FIG. 3B.

In this case, after the user operates a button on which a Korean consonant is displayed, the plurality of buttons 205 through 260 may display the plurality of Korean vowels illustrated in FIG. 3B. Likewise, after the user operates a button on which a Korean vowel is displayed, the plurality of buttons 205 through 260 may display the plurality of Korean consonants illustrated in FIG. 3A.

If the user operates a predetermined button, e.g., the twelfth button 260, of the plurality of buttons 205 through 260 on which the plurality of Korean consonants are displayed, the plurality of buttons 205 through 260 may display the plurality of Korean vowels illustrated in FIG. 3B. Similarly, if the user operates a predetermined button, e.g., the twelfth button 260, of the plurality of buttons 205 through 260 on which the plurality of Korean vowels are displayed, the plurality of buttons 205 through 260 may display the plurality of Korean consonants illustrated in FIG. 3A.

If the user operates a button on which a basic consonant is displayed for more than a predetermined time, a fortis consonant is input to the cellular phone 200. For example, if the user continuously presses the first button 205 of the plurality of buttons 205 through 260 illustrated in FIG. 3A for more than 1 second, [symbol] is input to the cellular phone 200. Likewise, [symbol] is input to the cellular phone 200 if the user continuously presses the ninth button 245 of the plurality of buttons 205 through 260 illustrated in FIG. 3A for more than 1 second, [symbol] is input to the cellular phone 200 if the user continuously presses the tenth button 250 of the plurality of buttons 205 through 260 illustrated in FIG. 3A for more than 1 second, [symbol] is input to the cellular phone 200 if the user continuously presses the third button 215 of the plurality of buttons 205 through 260 illustrated in FIG. 3A for more than 1 second, and [symbol] is input to the cellular phone 200 if the user continuously presses the eleventh button 255 of the plurality of buttons 205 through 260 illustrated in FIG. 3A for more than 1 second.

In addition, if the user operates a predetermined button, e.g., the fourth button 220, after operating a button on which a basic consonant is displayed, an aspiration consonant is input to the cellular phone 200. For example, [symbol] is input to the cellular phone 200 if the user presses the fourth button 220 after pressing the first button 205 among the plurality of buttons 205 through 260 illustrated in FIG. 3A, and [symbol] is input to the cellular phone 200 if the user presses the fourth button 220 after pressing the ninth button 245 among the plurality of buttons 205 through 260 illustrated in FIG. 3A. Similarly, [symbol] is input to the cellular phone 200 if the user presses the fourth button 220 after pressing the tenth button 250 among the plurality of buttons 205 through 260 illustrated in FIG. 3A, and [symbol] is input to the cellular phone 200 if the user presses the fourth button 220 after pressing the eleventh button 255 among the plurality of buttons 205 through 260 illustrated in FIG. 3A.

If the user simultaneously operates two buttons on which Korean consonants are displayed using two hands, a digraph composed of two different consonants is input to the cellular phone 200. For example, if the user simultaneously presses the first button 205 and the second button 210 among the plurality of buttons 205 through 260 illustrated in FIG. 3A, [symbol] is input to the cellular phone 200. Likewise, if the user simultaneously presses the third button 215 and the tenth button 250 among the plurality of buttons 205 through 260 illustrated in FIG. 3A, [symbol] is input to the cellular phone 200. Similarly, if the user simultaneously presses the second button 210 and the eighth button 240 among the plurality of buttons 205 through 260 illustrated in FIG. 3A, [symbol] is input to the cellular phone 200.

Even though the user operates two buttons on which Korean consonants are displayed one by one using one hand, a digraph can be input to the cellular phone 200. For example, if the user presses the first button 205 after pressing the second button 210 among the plurality of buttons 205 through 260 illustrated in FIG. 3A, [symbol] is input to the cellular phone 200. Likewise, if the user presses the third button 215 after pressing the tenth button 250 among the plurality of buttons 205 through 260 illustrated in FIG. 3A, [symbol] is input to the cellular phone 200. Similarly, if the user presses the second button 210 after pressing the eighth button 240 among the plurality of buttons 205 through 260 illustrated in FIG. 3A, [symbol] is input to the cellular phone 200.

In the same manner, if the user simultaneously operates two buttons on which Korean vowels are displayed using two hands, a diphthong is input to the cellular phone 200. For example, if the user simultaneously presses the eighth button 240 and the ninth button 245 among the plurality of buttons 205 through 260 illustrated in FIG. 3B, [symbol] is input to the cellular phone 200. Likewise, if the user simultaneously presses the sixth button 230 and the eighth button 240 among the plurality of buttons 205 through 260 illustrated in FIG. 3B, [symbol] is input to the cellular phone 200. Similarly, if the user simultaneously presses the first button 205 and the eighth button 240 among the plurality of buttons 205 through 260 illustrated in FIG. 3B, [symbol] is input to the cellular phone 200.

Even though the user operates two buttons on which Korean vowels are displayed one by one using one hand, a diphthong can be input to the cellular phone 200. For example, if the user presses the eighth button 240 after pressing the ninth button 245 among the plurality of buttons 205 through 260 illustrated in FIG. 3B, [symbol] is input to the cellular phone 200. Likewise, if the user presses the eighth button 240 after pressing the sixth button 230 among the plurality of buttons 205 through 260 illustrated in FIG. 3B, [symbol] is input to the cellular phone 200. Similarly, if the user presses the eighth button 240 after pressing the first button 205 among the plurality of buttons 205 through 260 illustrated in FIG. 3B, [symbol] is input to the cellular phone 200.

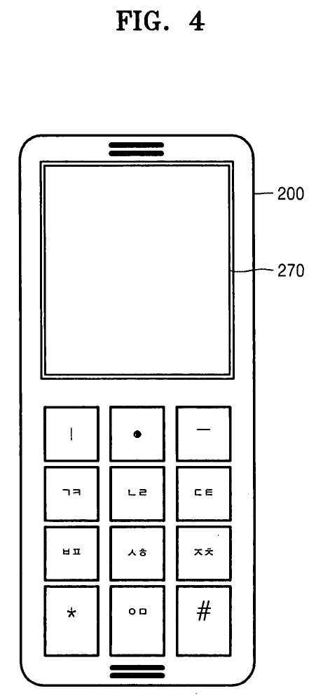

FIG. 4 is a reference diagram for explaining a button operation process required to edit a short message in Korean using the cellular phone 200 illustrated in FIG. 2, according to another exemplary embodiment.

According to the current exemplary embodiment, the plurality of buttons 205 through 260 display a plurality of Korean consonants, such as [symbol] [symbol] [symbol] and [symbol] , and [symbol] , and [symbol] .

In this case, if the user operates a button on which Korean consonants are displayed again within a predetermined time, a letter input to the cellular phone 200 is changed among more than one Korean consonant. For example, if the user presses the second button 210 again within 1 second after pressing the second button 210, a letter input to the cellular phone 200 is changed among [symbol] , and [symbol] . In detail, when a letter input to the cellular phone 200 is [symbol] if the user presses the second button 210 again within 1 second, the input letter is changed from [symbol] to [symbol] . Likewise, when a letter input to the cellular phone 200 is [symbol] , if the user presses the second button 210 again within 1 second, the input letter is changed from [symbol] to [symbol] . This change principle is also applied to other buttons 215, 230, 235, 240, 250, and 255. That is, if the user presses the sixth button 230 again within 1 second after pressing the sixth button 230, a letter input to the cellular phone 200 is changed among [symbol] and [symbol] . If the user presses the tenth button 250 again within 1 second after pressing the tenth button 250, a letter input to the cellular phone 200 is changed among [symbol] and [symbol] . If the user presses the third button 215 again within 1 second after pressing the third button 215, a letter input to the cellular phone 200 is changed among [symbol] and [symbol] . If the user presses the seventh button 235 again within 1 second after pressing the seventh button 235, a letter input to the cellular phone 200 is changed among [symbol] , and [symbol] . If the user presses the eleventh button 255 again within 1 second after pressing the eleventh button 255, a letter input to the cellular phone 200 is changed among [symbol] and [symbol] . If the user presses the eighth button 240 again within 1 second after pressing the eighth button 240, a letter input to the cellular phone 200 is changed among [symbol] and [symbol] .

If the user operates a button on which [symbol] is displayed again within a predetermined time, the number of strokes of a letter input to the cellular phone 200 is changed. For example, if the user presses the fifth button 225 within 1 second after pressing the first button 205, a letter input to the cellular phone 200 is changed from [symbol] to [symbol] , and if the user presses the fifth button 225 again within 1 second, the letter input to the cellular phone 200 is changed from [symbol] to [symbol] .

The user can input various Korean vowels, such as

[symbol]

[symbol]

[symbol]

, and [symbol] into the cellular phone 200 by properly operating the first button 205, the fifth button 225, and the ninth button 245.

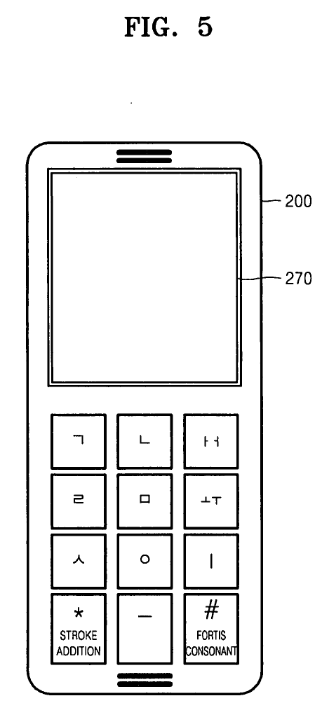

FIG. 5 is a reference diagram for explaining a button operation process required to edit a short message in Korean using the cellular phone 200 illustrated in FIG. 2, according to another exemplary embodiment.

According to the current exemplary embodiment, the plurality of buttons 205 through 260 display a plurality of Korean consonants, such as [symbol] , and [symbol] , a plurality of Korean vowels, such as [symbol] , and [symbol] , and special characters, such as * and #.

In this case, if the user operates a first predetermined button, e.g., the fourth button 220 after operating a button on which a Korean consonant is displayed, a letter input to the cellular phone 200 is changed among more than one Korean consonant. For example, if the user presses the fourth button 220 after pressing the first button 205, a letter input to the cellular phone 200 is changed among [symbol] and [symbol] . In detail, when a letter input to the cellular phone 200 is [symbol] , if the user presses the fourth button 220, the input letter is changed from [symbol] to [symbol] . This change principle is also applied to other buttons 215, 225, 230, and 235. That is, if the user presses the fourth button 220 after pressing the fifth button 225, a letter input to the cellular phone 200 is changed among [symbol] and [symbol] , and if the user presses the fourth button 220 after pressing the sixth button 230, a letter input to the cellular phone 200 is changed among [symbol] and [symbol] . In addition, if the user presses the fourth button 220 after pressing the third button 215, a letter input to the cellular phone 200 is changed among [symbol] , and [symbol] , and if the user presses the fourth button 220 after pressing the seventh button 235, a letter input to the cellular phone 200 is changed among [symbol] and [symbol] .

In the same manner, if the user operates a second predetermined button, e.g., the twelfth button 260 after operating a button on which a Korean consonant is displayed, a letter input to the cellular phone 200 is changed among more than one Korean consonant. For example, when a letter input to the cellular phone 200 is [symbol] , if the user presses the twelfth button 260, the input letter is changed from [symbol] to [symbol] . Likewise, if the user presses the twelfth button 260 when a letter input to the cellular phone 200 is [symbol] , the input letter is changed from [symbol] to [symbol] . If the user presses the twelfth button 260 when a letter input to the cellular phone 200 is [symbol] , the input letter is changed from [symbol] to [symbol] . If the user presses the twelfth button 260 when a letter input to the cellular phone 200 is [symbol] , the input letter is changed from [symbol] to [symbol] . If the user presses the twelfth button 260 when a letter input to the cellular phone 200 is [symbol] , the input letter is changed from [symbol] to [symbol] .

If the user operates the first predetermined button, e.g., the fourth button 220 after operating a button on which a Korean vowel is displayed, a letter input to the cellular phone 200 is changed among more than one Korean vowel. For example, if the user presses the fourth button 220 when a letter input to the cellular phone 200 is [symbol] , the input letter is changed from [symbol] to [symbol] . Likewise, if the user presses the fourth button 220 when a letter input to the cellular phone 200 is [symbol] , the input letter is changed from [symbol] to [symbol] .

Table 1 shows an example of inputting a short message [symbol] [symbol] using the button input processes according to exemplary embodiments illustrated in FIGS. 3A through 5. The button input process according to exemplary embodiment illustrated in FIGS. 3A and 3B is divided into a case where any of digraphs and diphthongs is input using one hand and a case where any of digraphs and diphthongs is input by simultaneously pressing two consonants or vowels using two hands. In Table 1, the simultaneous operation of two buttons is considered as a single operation.

TABLE 1

| Character input | | Input | |
|---|---|---|---|
| method | | counts | Key input sequence |
| Exemplary | One | 43 | [symbol] [symbol] [symbol] [symbol] [symbol] |
| Embodiment | hand | | [symbol] [symbol] [symbol] [symbol] [symbol] |
| illustrated in | | | [symbol] [symbol] [symbol] [symbol] [symbol] |
| | Two | 37 | [symbol] [symbol] [symbol] [symbol] [symbol] |
| and 3B | hands | | [symbol] [symbol] [symbol] [symbol] [symbol] |
| | | | [symbol] [symbol] [symbol] [symbol] |

| | | |
|---|---|---|
| Exemplary | 53 | [symbol] [symbol] [symbol] [symbol] [symbol] |
| Embodiment | | [symbol] [symbol] [symbol] [symbol] [symbol] |
| illustrated in FIG. 4 | | [symbol] [symbol] [symbol] [symbol] [symbol] |
| | | [symbol] [symbol] [symbol] [symbol] |
| Exemplary | 50 | [symbol] [symbol] [symbol] [symbol] [symbol] |
| Embodiment | | [symbol] [symbol] [symbol] [symbol] [symbol] |
| illustrated in FIG. 5 | | [symbol] [symbol] [symbol] [symbol] [symbol] |
| | | [symbol] [symbol] [symbol] |

In Table 1, [symbol] denotes an action that a button corresponding to a letter located just before the [symbol] mark is pressed for more than a predetermined time. For example, [symbol] denotes an action that the [symbol] button is pressed for more than 1 second. In addition, two consonants or vowels displayed together denote an action when two buttons corresponding to the two consonants or vowels are simultaneously pressed. For example, [symbol] in Table 1 denotes an action when the [symbol] button and the [symbol] button are simultaneously pressed using two hands.

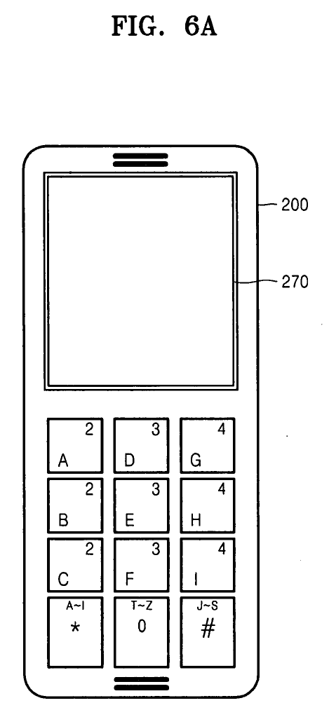

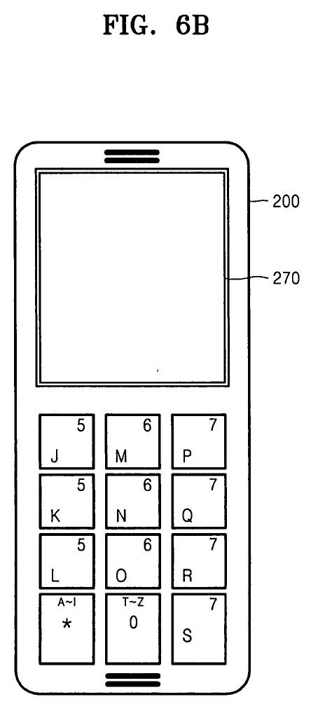

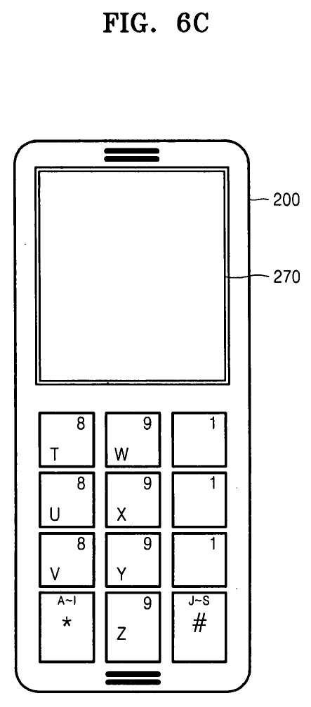

FIGS. 6A through 6C are reference diagrams for explaining a button operation process required to edit a short message in English using the cellular phone 200 illustrated in FIG. 2, according to an exemplary embodiment.

According to the current exemplary embodiment, when the plurality of buttons 205 through 260 display the characters (e.g. alphabet letters in FIGS. 6A through 6C), a single alphabet letter can be displayed on a single button as illustrated in FIGS. 6A through 6C. In this case, each of the plurality of buttons 205 through 260 may display a numeral together with an alphabet letter.

As illustrated in FIGS. 6A through 6C, the alphabet letters A to Z can be divided into groups. For example, the alphabet letters A to Z can be divided into a first group including letters A to I, a second group including letters J to S, and a third group including letters T to Z.

If the fourth button 220 is operated, the alphabet letters of the first group are displayed on the first, second, third, fifth, sixth, seventh, ninth, tenth, and eleventh buttons 205, 210, 215, 225, 230, 235, 245, 250, and 255 as illustrated in FIG. 6A. Likewise, if the twelfth button 260 is operated, the alphabet letters of the second group are displayed on the first, second, third, fifth, sixth, seventh, ninth, tenth, eleventh, and twelfth buttons 205, 210, 215, 225, 230, 235, 245, 250, 255, and 260 as illustrated in FIG. 6B. Similarly, if the eighth button 240 is operated, the alphabet letters of the third group are displayed on the first, second, third, fifth, sixth, seventh, and eighth buttons 205, 210, 215, 225, 230, 235, and 240 as illustrated in FIG. 6C.

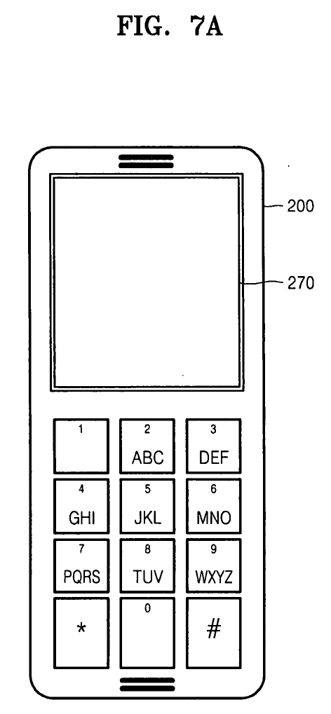

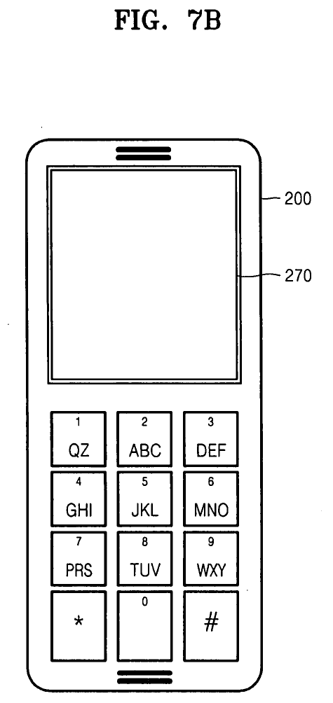

FIGS. 7A and 7B are reference diagrams for explaining a button operation process required to edit a short message in English using the cellular phone 200 illustrated in FIG. 2, according to another exemplary embodiment.

According to the current exemplary embodiment, when the plurality of buttons 205 through 260 display the alphabet letters, a plurality of alphabet letters can be displayed on a single button as illustrated in FIGS. 7A and 7B. In this case, each of the plurality of buttons 205 through 260 may display a numeral together.

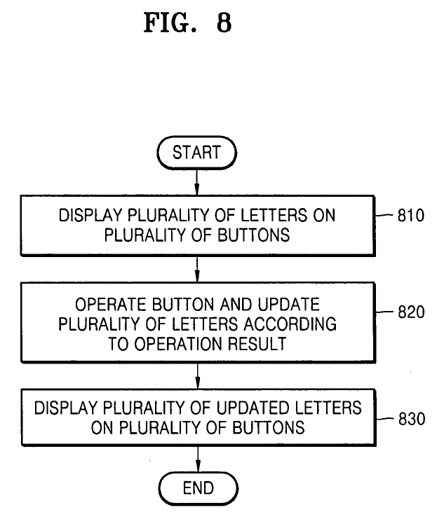

FIG. 8 is a flowchart illustrating a display method according to an exemplary embodiment. Referring to FIG. 8, the display method includes displaying a plurality of characters (e.g., letters) determined according to an operation result of a plurality of buttons included in a terminal on the plurality of buttons in operations 810 through 830.

In operation 810, the plurality of buttons 110 display a plurality of characters, and the user operates the plurality of buttons 110. In operation 820, the controller 100 updates a plurality of characters to be displayed on the plurality of buttons 110 according to an operation result.

In operation 830, the plurality of buttons 110 display the plurality of characters updated in operation 820.

In addition to the above-described exemplary embodiments, exemplary embodiments of the present invention can also be implemented by executing computer readable code/instructions in/on a medium/media, e.g., a computer readable medium/media. The medium/media can correspond to any medium/media permitting the storing and/or transmission of the computer readable code/instructions. The medium/media may also include, alone or in combination with the computer readable code/instructions, data files, data structures, and the like. Examples of code/instructions include both machine code, such as produced by a compiler, and files containing higher level code that may be executed by a computing device and the like using an interpreter. In addition, code/instructions may include functional programs and code segments.

The computer readable code/instructions can be recorded/transferred in/on a medium/media in a variety of ways, with examples of the medium/media including magnetic storage media (e.g., floppy disks, hard disks, magnetic tapes, etc.), optical media (e.g., CD-ROMs, DVDs, etc.), magneto-optical media (e.g., floptical disks), hardware storage devices (e.g., read only memory media, random access memory media, flash memories, etc.) and storage/transmission media such as carrier waves transmitting signals, which may include computer readable code/instructions, data files, data structures, etc. The medium/media may also be a distributed network, so that the computer readable code/instructions are stored/transferred and executed in a distributed fashion. The computer readable code/instructions may be executed by one or more processors. The computer readable code/instructions may also be executed and/or embodied in at least one application specific integrated circuit (ASIC) or Field Programmable Gate Array (FPGA).

In addition, one or more software modules or one or more hardware modules may be configured in order to perform the operations of the above-described exemplary embodiments.

The term “module”, as used herein, denotes, but is not limited to, a software component, a hardware component, a plurality of software components, a plurality of hardware components, a combination of a software component and a hardware component, a combination of a plurality of software components and a hardware component, a combination of a software component and a plurality of hardware components, or a combination of a plurality of software components and a plurality of hardware components, which performs certain tasks. A module may advantageously be configured to reside on the addressable storage medium/media and configured to execute on one or more processors. Thus, a module may include, by way of example, components, such as software components, application specific software components, object-oriented software components, class components and task components, processes, functions, operations, execution threads, attributes, procedures, subroutines, segments of program code, drivers, firmware, microcode, circuitry, data, databases, data structures, tables, arrays, and variables. The functionality provided for in the components or modules may be combined into fewer components or modules or may be further separated into additional components or modules. Further, the components or modules can operate at least one processor (e.g. central processing unit (CPU)) provided in a device. In addition, examples of a hardware components include an application specific integrated circuit (ASIC) and Field Programmable Gate Array (FPGA). As indicated above, a module can also denote a combination of a software component(s) and a hardware component(s). These hardware components may also be one or more processors.

The computer readable code/instructions and computer readable medium/media may be those specially designed and constructed for the purposes of the present invention, or they may be of the kind well-known and available to those skilled in the art of computer hardware and/or computer software.

As described above, in a terminal (mobile device) having buttons having a display function and a display method for the terminal according to an exemplary embodiment, since a plurality of characters determined according to an operation result of a plurality of buttons included in the terminal are displayed on the plurality of buttons, the size of the buttons does not have to be reduced even though the number of functions available in the terminal is many, thereby increasing user's convenience for operating the buttons. In addition, since the usage of the buttons is variably displayed all over the buttons without engraving it on the surface of the buttons, even a user who had experienced difficulty to identify the usage of the conventional buttons, which was engraved small on the surface thereof, can easily identify the usage of the buttons. Furthermore, since the usage which the user currently desires to operate is predicted and displayed when the usage of the buttons are displayed, the user does not have to repeatedly press the same button to operate a desired button. In addition, since the number of buttons included in the terminal (mobile device) can be reduced, market competitiveness can be strengthened through miniaturization of the terminal (mobile device). In addition, since the buttons having a display function can display various characters, the terminal (mobile device) having buttons having a display function can provide various character input methods.

Although a few exemplary embodiments have been shown and described, it would be appreciated by those skilled in the art that changes may be made in these exemplary embodiments. The scope of the invention is defined in the claims and their equivalents.

What is claimed is:

1. A mobile device comprising:
a plurality of buttons, which display a plurality of characters in response to a control signal; and
a controller which generates the control signal for commanding the plurality of buttons to display characters indicated by character data corresponding to an operation result of at least one button from among predetermined character data.

2. The mobile device of claim 1, wherein the plurality of buttons display a plurality of Korean consonants or vowels.

3. The mobile device of claim 2, wherein if one of the plurality of buttons on which the plurality of Korean consonants are displayed is operated, the plurality of buttons display the plurality of Korean vowels, and if one of the plurality of buttons on which the plurality of Korean vowels are displayed is operated, the plurality of buttons display the plurality of Korean consonants.

4. The mobile device of claim 2, wherein if a predetermined button is operated when the plurality of buttons display the plurality of Korean consonants, the plurality of buttons display the plurality of Korean vowels, and if the predetermined button is operated when the plurality of buttons display the plurality of Korean vowels, the plurality of buttons display the plurality of Korean consonants.

5. The mobile device of claim 2, wherein when a button on which a basic Korean consonant is displayed is operated for more than a predetermined time, a character input to the mobile device is a fortis consonant.

6. The mobile device of claim 2, wherein when a predetermined button is operated after operating a button on which a basic Korean consonant is displayed, a character input to the mobile device is an aspiration consonant.

7. The mobile device of claim 2, wherein when two of buttons on which Korean consonants are displayed are simultaneously pressed, a character input to the mobile device is a digraph.

8. The mobile device of claim 2, wherein when two of buttons on which Korean vowels are displayed are simultaneously pressed, a character input to the mobile device is a diphthong.

9. The mobile device of claim 2, wherein the plurality of Korean consonants comprise [symbol] [symbol] and [symbol] , and the plurality of Korean vowels comprise [symbol] [symbol] and [symbol] .

10. The mobile device of claim 1, wherein the plurality of characters comprise a plurality of Korean consonants, [symbol] and [symbol] , and if one of the buttons on which the Korean consonants are displayed is operated again within a predetermined time, a character input to the mobile device is changed among more than one Korean consonant, and if the button on which [symbol] is displayed is operated again within the predetermined time, the number of strokes of a Korean vowel input to the mobile device is changed.

11. The mobile device of claim 10, wherein the plurality of characters comprise [symbol] [symbol] [symbol] [symbol] and [symbol] , and a character input to the mobile device is changed among [symbol] and [symbol] if a button on which [symbol] and [symbol] are displayed is operated again within a predetermined time, a character input to the mobile device is changed among [symbol] and [symbol] if a button on which [symbol] and [symbol] are displayed is operated again within the predetermined time, a character input to the mobile device is changed among [symbol] and [symbol] if a button on which [symbol] and [symbol] are displayed is operated again within the predetermined time, a character input to the mobile device is changed among [symbol] , and [symbol] if a button on which [symbol] and [symbol] are displayed is operated again within the predetermined time, a character input to the mobile device is changed among [symbol] and [symbol] if a button on which [symbol] and [symbol] are displayed is operated again within the predetermined time, a character input to the mobile device is changed among [symbol] and [symbol] if a button on which [symbol] and [symbol] are displayed is operated again within the predetermined time, and a character input to the mobile device is changed among [symbol] and [symbol] if a button on which [symbol] and [symbol] are displayed is operated again within the predetermined time.

12. The mobile device of claim 1, wherein the plurality of characters comprise a plurality of Korean consonants and a plurality of Korean vowels, and if a predetermined button is operated after operating one of the buttons on which the plurality of Korean consonants are displayed, a character input to the mobile device is changed among more than one Korean consonant, and if the predetermined button is operated after operating one of the buttons on which the plurality of Korean vowels are displayed, a character input to the mobile device is changed among more than one Korean vowel.

13. The mobile device of claim 12, wherein the plurality of characters comprise [symbol] , [symbol] [symbol] , and [symbol] , and the plurality of buttons comprise a first predetermined button and a second predetermined button, and a character input to the mobile device is changed among [symbol] and [symbol] if the first predetermined button is operated after operating a button on which [symbol] is displayed, a character input to the mobile device is changed among [symbol] , and [symbol] if the first predetermined button is operated after operating a button on which [symbol] is displayed, a character input to the mobile device is changed among [symbol] , and [symbol] if the first predetermined button is operated after operating a button on which [symbol] is displayed, a character input to the mobile device is changed among [symbol] , and [symbol] if the first predetermined button is operated after operating a button on which [symbol] is displayed, a character input to the mobile device is changed among [symbol] and [symbol] if the first predetermined button is operated after operating a button on which [symbol] is displayed, the number of strokes of a character input to the mobile device is changed if the first predetermined button is operated after operating a button on which [symbol] and [symbol] or [symbol] and [symbol] are displayed, and if the second predetermined button is operated after operating a button on which a basic Korean consonant is displayed, a letter input to the mobile device is changed to a fortis consonant.

14. The mobile device of claim 1, wherein the plurality of buttons display a plurality of alphabet letters corresponding to an operation result of the button.

15. The mobile device of claim 1, wherein the plurality of buttons display a plurality of numerals corresponding to an operation result of the button.

16. The mobile device of claim 1, wherein the predetermined character data is stored in the mobile device or outside of the mobile device.

17. The mobile device of claim 1, wherein each of the plurality of buttons is operated by pressing or touching.

18. A display method performed in a mobile device having a plurality of buttons, the method comprising:
displaying a plurality of characters on the plurality of buttons;
operating at least one button and updating the plurality of characters according to the operation result; and
displaying the plurality of updated characters on the plurality of buttons.

19. At least one computer readable medium storing computer readable instructions to implement a display method performed in a mobile device having a plurality of buttons, the method comprising:
displaying a plurality of characters on the plurality of buttons;
operating at least one button and updating the plurality of characters according to the operation result; and
displaying the plurality of updated characters on the plurality of buttons.

20. The display method of claim 18, wherein the characters are a plurality of English letters.

21. The display method of claim 18, wherein the characters are Korean consonants, Korean vowels, or Korean consonants and Korean vowels.

22. The display method of claim 18, wherein the characters are a numbers.

23. At least one computer readable medium as recited in claim 19, wherein the characters are a plurality of English letters.

24. At least one computer readable medium as recited in claim 19, wherein the characters are a plurality of Korean consonants, Korean vowels, or Korean consonants and Korean vowels.

25. At least one computer readable medium as recited in claim 19, wherein the characters are numbers.
